(19) United States
(12) Patent Application Publication
(10) Pub. No.: US 2008/0301275 A1
(43) Pub. Date: Dec. 4, 2008

(54) MANAGED RACKING SYSTEM

(75) Inventor: Kevin E. Barry, Beaumont Hills (AU)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/755,766

(22) Filed: May 31, 2007

(51) Int. Cl. G06F 15/173

(52) U.S. Cl. 709/223

(57) ABSTRACT

An optimized racking system is disclosed for computer installation to communicate with a computer network. This system comprises a plurality of server modules, a plurality of switching modules and a central patching facility. Each of the server modules is adapted to receive at least one server computer, and each of the switching modules is adapted to receive at least one communications switch. The central patching facility is adapted to connect at least one switch for communication with at least one remote computer.

### BACKGROUND OF THE INVENTION

1. Field of the Invention

This invention generally relates to computer installations, and more specifically, to addressing the current business problem of uncoordinated purchase of racks, power cabling and raised floor utilization for computer installations.

2. Background Art

Today, businesses generally do not coordinate the purchase of the components of a computer installation. The purchase and installation of computer installation may be done on a case-by-case basis by solutioning and provisioning. Individual solutions are custom designed and may range from one to eight servers, and the time from design to deployment ranges, as a common example, from six to eight weeks.

The solutioning and provisioning of computer installations on a case-by-case basis is inefficient in terms of duplication of work and point solutions for both data and power cabling. Also, current systems are unable to reuse infrastructure for point solutions. The current process is very labor intensive. Also, end-to-end configuration management of equipment, cables, switch and network is too difficult to track with rapid changing environment.

### SUMMARY OF THE INVENTION

An object of this invention is to provide an optimized racking system for computer installations to communicate with a computer network.

Another object of the present invention is to address the current business problem of uncoordinated purchase of racks, power, cabling and raised floor utilization.

In accordance with a first aspect of the invention, an optimized racking system is provided for computer installation to communicate with a computer network. This system comprises a plurality of server modules, a plurality of switching modules and a central patching facility. Each of the server modules is adapted to receive at least one server computer, and each of the switching modules is adapted to receive at least one communications switch. The central patching facility is adapted to connect at least one switch for communication with at least one remote computer.

Also, each of the server modules has a preinstalled power cable adapted to supply operating power to said at least one server, and each switching module has at least one preinstalled cable having a connector adapted to connect the switching module with the central patching facility. This central patching facility has at least one preinstalled cable adapted to connect the patching facility to a computer network comprising at least one of a switch pod, server pod and remote services.

In accordance with a second aspect of the invention, a method is provided of determining requirements for the installation of a rack of server computers, switches and cables adapted to communicate with a computer network. This method comprises the steps of establishing fixed costing per unit of cable; establishing fixed costing per unit of labor for installation of each server, each rack and each switch; and establishing a fixed physical layout for each server, each rack and each switch, said physical layout including a cabling pattern. The method comprises further the steps of providing the number of servers and switches required for an installation; and from said fixed costing and physical layout elements, determining space and cost requirements for said installation of servers and switches.

The preferred embodiment of the invention utilizes existing SQL server production database and its associated schema as the back end. The invention utilizes separate modules, defined by the type of information and the policy and responsibilities defined in managing the system. The invention may provide reports and updates, and may include links to raised floor diagrams. Links may also be provided to existing asset tracking databases. Also, data may be tracked manually.

Further benefits and advantages of this invention will become apparent from a consideration of the following detailed description, given with reference to the accompanying drawings, which specify and show preferred embodiments of the invention.

### BRIEF DESCRIPTION OF THE DRAWINGS

FIG. 1 shows a managed racking system embodying the present invention.

FIG. 2 schematically illustrated a racking system embodying this invention.

FIG. 3 illustrates a computer system that may be used to carry out this invention.

### DETAILED DESCRIPTION OF THE PREFERRED EMBODIMENTS

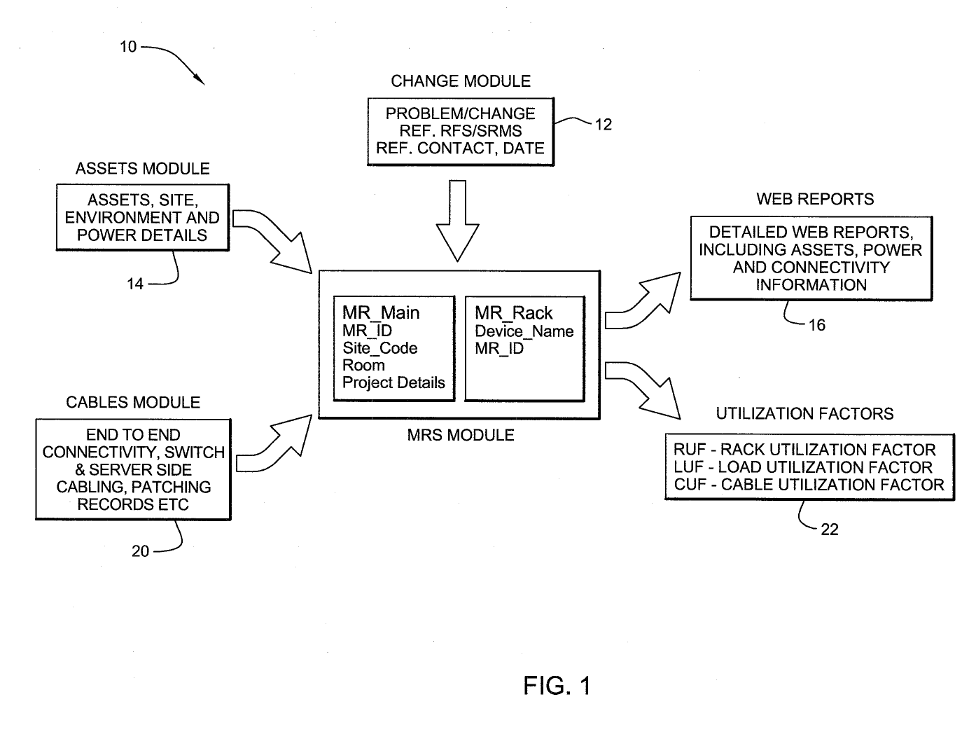

FIG. 1 shows a managed racking system module 10 embodying this invention. Generally, module 10 includes Change module, 12, Asset module 14, Web Results module 16, Cables module 20 and Utilization Factor module 22. The following describes how the modules interact with the managed racking system.

Change Module: This will keep track of all changes associated to a particular piece of equipment, based on SRMS/RFS/Change/Problem record references, contact name of person completing change (DCMS or otherwise), type of change, and comments. This link will be based on Serial Number of the device.

Assets Module: This feed will come direct from the SQL Server Database maintained by Data Center Management Services (DCMS) as the Aperture back-end. DCMS will be responsible to maintain Top Down, Power and Elevation data for the MRS and server/networking assets within. For Westpac systems, a further link is established to exchange information with the WETS database.

Web Reports module: Provides detailed web reports including assets, power and connectivity information.

Cable Module: The Cabling contractor will provide information regarding all fixed cabling (Switch to VisiPatch and Server Cabinet to VisiPatch). This is fixed information—once MRS module is established, there is very little chance that this information needs to be updated.

Utilization Factors module: Monitors utilization of equipment, and provides a rack utilization factor, a load utilization factor and a cable utilization factor.

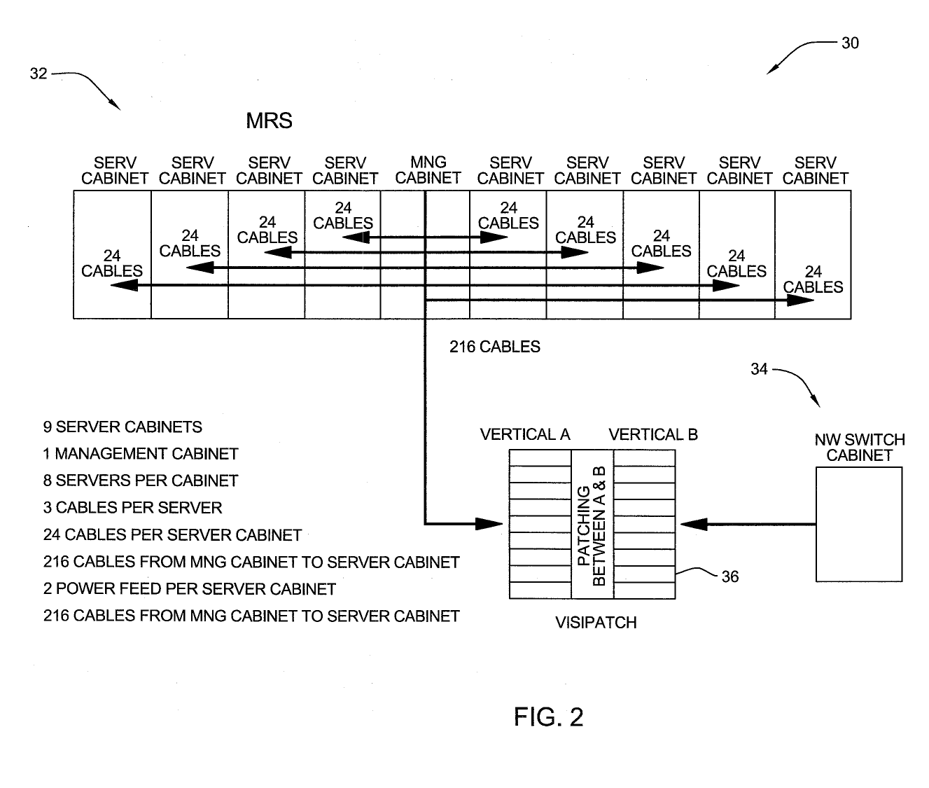

FIG. 2 shows a racking system 30 designed by the present invention. System is an optimized racking system provided for computer installation to communicate with a computer network. This system comprises a plurality of server modules 32, a plurality of switching modules and a central patching facility 36. Each of the server modules is adapted to receive at least one server computer, and each of the switching modules is adapted to receive at least one communications switch. The central patching facility 36 is adapted to connect at least one switch for communication with at least one remote computer.

Also, each of the server modules has a preinstalled power cable adapted to supply operating power to said at least one server, and each switching module has at least one preinstalled cable having a connector adapted to connect the switching module with the central patching facility. This central patching facility has at least one preinstalled cable adapted to connect the patching facility to a computer network comprising at least one of a switch pod, server pod and remote services. Preferably, the plurality of server modules are adapted to be mounted in at least one server pod, and the plurality of switching modules are adapted to be mounted in at least one switch pod.

In accordance with another aspect of the invention, a method is provided of determining requirements for the installation of a rack of server computers, switches and cables adapted to communicate with a computer network. This method comprises the steps of establishing fixed costing per unit of cable; establishing fixed costing per unit of labor for installation of each server, each rack and each switch; and establishing a fixed physical layout for each server, each rack and each switch, said physical layout including a cabling pattern.

The method comprises further the steps of providing the number of servers and switches required for an installation; and from said fixed costing and physical layout elements, determining space and cost requirements for said installation of servers and switches.

Preferably, this method further comprises the steps of providing predetermined heat load generated by each server, and a predetermined maximum total heat load available in said installation; comparing the planned number of servers in a server pod to a predetermined maximum number of servers in said pod; and if the planned number of servers exceeds the maximum number, incrementing the number of server pods by one. Also, in this preferred embodiment, the planned number of cables used in said server pod is compared to a predetermined maximum number of cables in this pod; and if that planned number of cables exceeds the maximum number, the number of cables is incremented.

The preferred method also comprises the steps of comparing the planned amount of heat generated by said servers to the predetermined maximum total heat load; and if the planned heat load exceeds the maximum allowable heat load, outputting a requirement to perform at least one of: obtaining increased cooling capacity and rearranging the physical layout of the system. In addition, preferably, the above described method steps are performed at the time of preparing an order for the system.

The racking system of the present invention can be modified as per existing model at time of order. All cable and labeling is provided and installed as per the predictive model. Once on site, preferably, the configuration is locked and is not changed. The system is preferably designed to house nearly all profiles of midrange and NT equipment. This is an open system, allowing connectivity to, for instance, IBM on demand systems or, if required, connectivity to customer specified systems.

The preferred racking system provides an existing base infrastructure which may form the foundation for midrange and NT designs. Installations (assuming equipment is available) can be completed twenty-four hours after the request is put into the system and configured. There is no need to pull cables or run power. This results in reduced cost and reduction of availability issues related to changes under the floor.

In the process of the present invention, planning, capacity management (heat, space, connectivity) are all easy to track with a manufacture system. The process may use a federated database to take flat files, and is web enabled to represent end-to-end configuration and capacity items. Also, since the system is fully manufactured (cables, labeling, fully lumbed switches, etc.), end-to-end configuration is easily tracked.

As will be readily apparent to those skilled in the art, the present invention, or aspects of the invention, can be realized in hardware, software, or a combination of hardware and software. Any kind of computer/server system(s)—or other apparatus adapted for carrying out methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

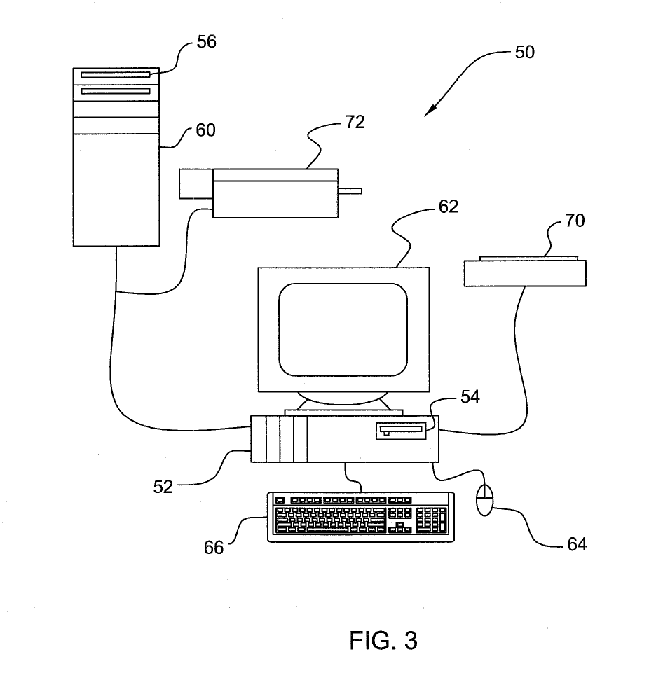

For example, FIG. 3 illustrates a computer system 50 which may be used in the implementation of the present invention may be carried out. Computer system 50 includes a processing unit 52 that houses a processor, memory and other systems components that implement a general purpose processing system that may execute a computer program product comprising media, for example a floppy disc that may be read by processing unit 52 through floppy drive 54.

The program product may also be stored on hard disk drives within processing unit 52 or may be located on a remote system 56 such as a server 60, coupled to processing unit 52, via a network interface, such as an Ethernet interface. Monitor 62, mouse 64 and keyboard 66 are coupled to processing unit 52, to provide user interaction. Scanner 70 and printer 72 are provided for document input and output. Printer 72 is shown coupled to processing unit 52 via a network connection, but may be coupled directly to the processing unit. Scanner 70 is shown coupled to processing unit 52 directly, but it should be understood that peripherals may be network coupled or direct coupled without affecting the ability of workstation computer 50 to perform the method of, or aspects of, the invention.

The present invention, or aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art, and it is intended that the appended claims cover all such modifications and embodiments as fall within the true spirit and scope of the present invention.

What is claimed is:

1. An optimized racking system for computer installations to communicate with a computer network, comprising:
a plurality of server modules each adapted to receive at least one server computer;
a plurality of switching modules each adapted to receive at least one communications switch;
a central patching facility adapted to connect said at least one switch for communication with at least one remote computer;
each said server module having at least one preinstalled cable having a connector adapted to provide communications between said at least one server computer and said at least one switch;
each said server module having a preinstalled power cable adapted to supply operating power to said at least one server;
each said switching module having at least one preinstalled cable having a connector adapted to connect said switching module with said central patching facility; and
said central patching facility having at least one preinstalled cable adapted to connect said patching facility to a computer network comprising at least one of a switch pod, server pod and remote services.

2. A system according to claim 1, wherein said plurality of server modules are adapted to be mounted in at least one server pod, and said plurality of switching modules are adapted to be mounted in at least one switch pod.

3. A method of determining requirements for the installation of a rack of server computers, switches and cables adapted to communicate with a computer network, comprising the steps of:
establishing fixed costing per unit of cable;
establishing fixed costing per unit of labor for installation of each server, each rack and each switch;
establishing a fixed physical layout for each server, each rack and each switch, said physical layout including a cabling pattern;
providing the number of servers and switches required for an installation; and
from said fixed costing and physical layout elements, determining space and cost requirements for said installation of servers and switches.

4. A method as claimed in claim 3, further comprising the steps of:
providing predetermined heat load generated by each server, and a predetermined maximum total heat load available in said installation;
comparing the planned number of servers in a server pod to a predetermined maximum number of servers in said pod;
if the planned number of servers exceeds said maximum number, incrementing the number of server pods by one;
comparing the planned number of cables used in said server pod to a predetermined maximum number of cables in said pod;
if the planned number of cables exceeds said maximum number, incrementing the number of cables;
comparing the planned amount of heat generated by said servers to said predetermined maximum total heat load; and
if the planned heat load exceeds the maximum allowable heat load, outputting a requirement to perform at least one of: obtaining increased cooling capacity and rearranging the physical layout of the system.

5. A method as claimed in claim 4, wherein all of the steps of the method are performed at the time of preparing an order for the system.
